(19) United States
(12) Patent Application Publication
(10) Pub. No.: US 2010/0123626 A1
(43) Pub. Date: May 20, 2010

(54) MOBILE STATION POSITION LOCATING METHOD, POSITION LOCATING BASE-STATION SELECTING METHOD AND MOBILE STATION POSITION LOCATING SYSTEM

(76) Inventor: Yoshiki Yano, Aichi-gun (JP)

Correspondence Address: DAY PITNEY LLP, 7 TIMES SQUARE, NEW YORK, NY, 10036-7311, US

(21) Appl. No.: 12/621,610

(22) Filed: Nov. 19, 2009

(30) Foreign Application Priority Data
Nov. 20, 2008 (JP) 2008-297401

(51) Int. Cl. G01S 1/08

(52) U.S. Cl. 342/386

(57) ABSTRACT

A mobile station position locating system is provided in which having a provisional position locating section sets base station set and locate a position of a mobile station as a provisional position locating result using the base station set. A provisional position locating result-group extracting section extracts a provisional position locating result associated with the base station set not including a specified base station, among provisional position locating results. A variation calculating section calculates a variation σ of a provisional position locating result group with each base station being assigned to a specified base station, and a position locating base-station setting section sets a position locating base station excluding the base station assigned to the specified base station, among the provisional position locating result groups with the least variations. A mobile station position locating section locates the position of the mobile station based on position locating results using the base station set constituted of the position locating base stations.

### BACKGROUND OF THE INVENTION

1. Field of the Invention

This invention relates to a mobile station position locating method and a mobile station position locating system, in which either one of a mobile station or a plurality of position locating base stations transmits a radio wave and the other one of the mobile station and the plurality of position locating base stations receives the radio wave to locate a position of the mobile station based on a received result, and a position locating base-station selecting method for selecting the position locating base stations.

2. Description of the Related Art

There has heretofore been known a mobile station position locating system in which either one of a mobile station or a plurality of position locating base stations transmits a radio wave and the other one of them receives the radio wave to calculate or locate a position of the mobile station based on a result of received wave. Such a mobile station position locating system is disclosed in for instance Patent Publication 1 (JP2002-77976A).

In such a mobile station position locating system, results on wireless communication between the mobile station and plural base stations are used. Under a circumstance where there exist the base stations exceeding the number of base stations required for locating the position of the mobile station, it is possible to select which result on wireless communication between the mobile station and any of the plural base stations is used. In such a case, position locating precision depends on the selected communication result, i.e., the communication result between the mobile station and any of the plural base stations. More particularly, if wireless communications between the mobile station and the base stations are poor in reliability due to adverse affects such as reflected waves and jamming waves or the like, there is a fear of degradation in precision of a position locating result using such a result of received wave.

As a method of addressing such a subject, there is a technology in which, based on wireless signal received by the mobile station at a maximum signal level among wireless signals transmitted from the plural base stations, base stations present in an area spaced by a given distance from a position of the base station related to such a wireless signal are selected.

However, when evaluating the wireless communications between the mobile station and the base stations depending on the reception level, it is likely that the reception level suffers adverse affects such as a multipath or the jamming waves, resulting in less success in correct evaluation. That is, there is likelihood that a base station having a high reception level, does not have increased reliability in wireless communication between the mobile station and the base stations.

### SUMMARY OF THE INVENTION

The present invention has been completed with the above views in mind, and has an object to provide a position locating base-station selecting method for selecting, as position locating base stations, base station(s) excluding the base station(s) susceptible to interference such as jamming waves or a multipath, a mobile station position locating method and a mobile station position locating system for locating a position of the mobile station using the position locating base station(s) being selected.

For achieving the above object, in a first aspect of the present invention, in a mobile station position locating method, one of a mobile station or a plurality of position locating base stations transmits a radio wave, and the other of the mobile station and the plurality of position locating base stations receives the radio wave to locate the position of the mobile station based on a result of received wave.

The mobile station position locating method comprising steps of: (a) a provisional position locating step that, setting among plural base stations a plurality of base station sets which are combinations of a predetermined number of base stations less than the number of plural base stations, locates the position of the mobile station using the plurality of base station sets; (b) a provisional position locating result group extracting step that extracts, among provisional position locating results associated with the base station sets which are set in the provisional position locating step for the respective base station sets, the provisional position locating results associated with the plurality of base station sets each not including a specified base station, as provisional position locating result groups; (c) a variation calculating step that calculates respective variations of the provisional position locating result groups obtained in the provisional position locating result group extracting step, by assigning each of at least one of the plural base stations to the specified base station; (d) a position locating base station setting step that sets the base stations excluding the base station assigned to the specified base station as the position locating base stations, on calculating the provisional position locating result group with the least variation among the variations of the provisional position locating result groups calculated in the variations calculating step; and (e) a mobile station position locating step that locates the position of the mobile station, based on the position locating results obtained by using the base station sets constituted of the position locating base stations which are set in the position locating base station setting step.

In a second aspect of the present invention, a position locating base station selecting method selects, on locating a position of a mobile station based on at received result of a radio wave transmitted from one of the mobile station or the plurality of position locating base stations received at other of the mobile station and a plurality of position locating base stations, the plurality of position locating base stations among plural base stations whose number of base stations exceeds a number required as the plurality of position locating base stations.

The position locating base station selecting method comprising step of: (a) a provisional position locating step that, setting among plural base stations a base station set which is combination of a predetermined number of base stations less than the number of plural base stations, locates the position of the mobile station using the base station set; (b) a provisional position locating result group extracting step that extracts, among provisional position locating results associated with the base station sets which are set in the provisional position locating step for the respective base station sets, the provisional position locating results associated with the plurality of base station sets each not including a specified base station, as provisional position locating result groups; (c) a variation calculating step that calculates respective variations of the provisional position locating result groups obtained in the provisional position locating result group extracting step, by assigning each of at least one of the plural base stations to the specified base station; and (d) a position locating base station setting step that sets the base stations excluding the base station assigned to the specified base station as the position locating base stations, on calculating the provisional position locating result group with the least variation among the variations of the provisional position locating result groups calculated in the variations calculating step.

In a third aspect of the present invention, in mobile station position locating system, one of a mobile station or a plurality of position locating base stations transmits a radio wave, and the other of the mobile station and the plurality of position locating base stations receives the radio wave to locate the position of the mobile station based on a result of received wave.

The mobile station position locating system comprising: (a) a provisional position locating section that, setting among plural base stations a base station set which is combination of a predetermined number of base stations less than the number of plural base stations, locates the position of the mobile station using the base station set; (b) a provisional position locating result group extracting section that extracts, among provisional position locating results associated with the base station sets which are set in the provisional position locating section for the respective base station sets, the provisional position locating results associated with the plurality of base station sets each not including a specified base station, as provisional position locating result groups; (c) a variation calculating section that calculates respective variations of the provisional position locating result groups obtained in the provisional position locating result group extracting section, by assigning each of at least one of the plural base stations to the specified base station; (d) a position locating base station setting section that sets the base stations excluding the base station assigned to the specified base station as the position locating base stations, on calculating the provisional position locating result group with the least variation among the variations of the provisional position locating result groups calculated in the variations calculating section; and

a mobile station position locating section that locates the position of the mobile station, based on the position locating results obtained by using the base station sets constituted of the position locating base stations which are set in the position locating base station setting section.

With the mobile station position locating method in the first aspect, the base stations excluding the specified base station which is susceptible to interference caused by jamming waves and a multipath, can be selected as the position locating base stations used for position-locating. Thus, the position of the mobile station can be located using these position locating base stations.

With the position locating base station selecting method in the second aspect, the base stations excluding the specified base station which is susceptible to interference caused by the jamming waves or the multipath, can be selected as the position locating base stations used for position-locating.

With the mobile station position locating system in the third aspect, the base stations excluding the specified base station susceptible to interference caused by the jamming waves or the multipath, can be selected as the position locating base stations used for position-locating. Thus, the position of the mobile station can be located using these position locating base stations.

### BRIEF DESCRIPTION OF THE DRAWINGS

FIG. 1 is a view illustrating an outline of a mobile station position locating system of one embodiment according to the present invention.

FIG. 2 is a view illustrating an outline of a function of a mobile station forming the mobile station position locating system shown in FIG. 1.

FIG. 3 is a view illustrating an outline of a function of a base station forming the mobile station position locating system shown in FIG. 1.

FIG. 4 is a view illustrating an outline of a function of a server forming the mobile station position locating system shown in FIG. 1.

FIG. 5 is a view illustrating the relationship between magnitude of receiving intensity of a radio wave transmitted from the mobile station for locating a position thereof and received by the base station, and a distance between the mobile station and the base station.

FIG. 6 is a view illustrating how the position of the mobile station is located using base station set determined by a provisional position locating section shown in FIG. 4.

FIG. 7 is a view illustrating the base station set, provisional position locating result using such base station set, and the provisional position locating result forming provisional position locating result group with the base station being assigned to a specified base station, respectively.

FIGS. 8A to 8E are views illustrating how a variation calculating section calculates variation of the provisional position locating result groups to assign the respective base stations to the specified base station.

FIG. 9 is a flowchart illustrating an outline of a control operations to be executed by the mobile station position locating system of one embodiment according to the present invention.

FIG. 10 is a flowchart illustrating a control operation of a position locating base station setting and mobile station position locating routine executed in the flowchart shown in FIG. 9.

FIG. 11 is a flowchart illustrating another example of a control operation of the position locating base station setting and mobile station position locating routine executed in the flowchart shown in FIG. 9.

FIG. 12 is a view illustrating another example representing how the variation calculating section calculates the variation of the provisional position locating result group.

FIG. 13 is a view illustrating still another example representing how the variation calculating section calculates the variations of the provisional position locating result group.

### DETAILED DESCRIPTION OF THE PREFERRED EMBODIMENTS

Now, one embodiment of the present invention will be described below in detail with reference to the accompanying drawings.

### First Embodiment

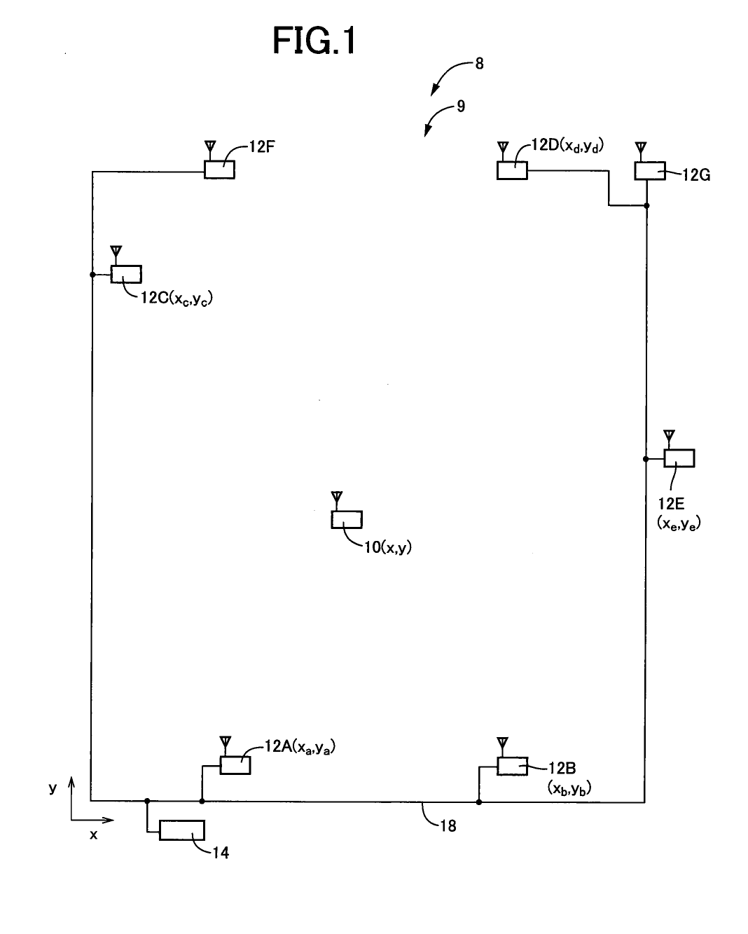

In FIG. 1, a mobile station position locating system 8 includes: a mobile station 10, moveable on for instance a flat plane parallel to a sheet of a FIG. 1; plural base stations, placed at known positions, which involve first, second, third, fourth, fifth, sixth and seven base stations 12A, 12B, 12C, 12D, 12E, 12F and 12G (hereinafter referred to as “base stations 12” unless otherwise distinguished from each other); and a server 14 connected to the base stations 12 via for instance a communication cable 18 to perform an information communication. The mobile station position locating system 8 has the number of base stations 12 exceeding a minimal number of the base stations required for locating the position of the mobile station 10. In the mobile station position locating system 8, further, a coordinate is defined in a manner for instance as shown in FIG. 1 for representing positions of the base stations 12, and the like. In the following description, the mobile station 10 is described with a coordinate (x, y); the first base station 12A with a coordinate (xa, ya); the second base station 12B with a coordinate (xb, yb); the third base station 12C with a coordinate (xc, yc); the fourth base station 12D with a coordinate (xd, yd).

The mobile station 10 and the base stations 12 are enabled to perform wireless communication with each other. Likewise, the base stations 12 can perform a wireless communication with each other. The mobile station 10 and the base stations 12 transmit radio waves involving identification codes (ID) and unique spread codes, respectively. Upon receipt of such a radio wave, it is possible to identify which of the mobile station 10 or any of the base stations 12 has transmitted the radio wave. With a sequence of coding and decoding being incorporated in common, information can be exchanged between the mobile station 10 and the base stations 12, and between the base stations 12.

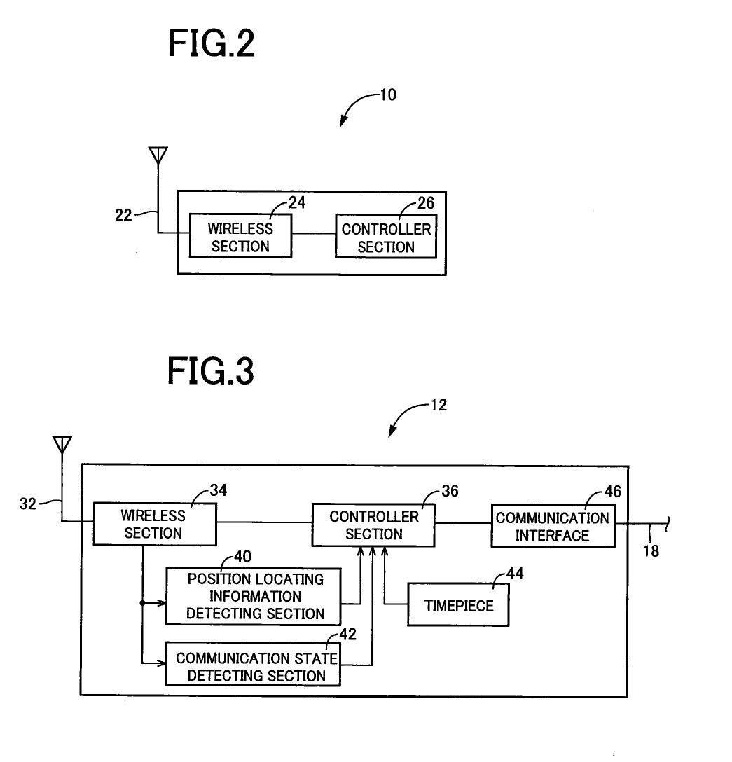

As shown in FIG. 2, the mobile station 10 having an antenna 22 for transmission and reception of the radio wave, includes a wireless section 24 having a function to transmit and receive the radio wave and a controller section 26 for controlling the wireless section 24.

Here, for the base stations 12 operative to receive the radio wave transmitted from the mobile station 10, the base stations 12 spaced from the mobile station 10 by an equal distance, may preferably receive the radio wave with equal receiving intensities, regardless of orientations with respect to the mobile station 10. To this end, an antenna with no directional characteristic may be preferably employed as the antenna 22.

The wireless section 24, operative to allow the mobile station 10 to perform transmission and reception of the radio wave, has a transmitting state and a receiving state that are switched by the controller section 26. During transmission of the radio wave, the wireless section 24 transmits via the antenna 22 the radio wave involving a control content such as a content of a signal waveform, a frequency and a transmit output of a carrier wave etc. which is commanded by the controller section 26. To this end, the wireless section 24 is comprised of a carrier wave generation circuit, a modulator and a transmission amplifier, etc. During reception of the radio wave, further, the wireless section 24 amplifies the radio wave received at the antenna 22 and executes given or predetermined demodulating processing or the like for thereby extracting a signal wave. That is, the wireless section 24 is structured to have a receiving amplifier and a demodulator, etc. When transmitting the radio waves to the respective base stations 12 for locating positions thereof, the wireless section 24 transmits the radio wave in the form of a predetermined given transmit output.

The controller section 26 serves to control the operation of the mobile station 10, and more particularly, processes information received at the wireless section 24, and controls the operation of the wireless section 24, i.e., more particularly, controls the transmit output and a transmit frequency or the like and generates a signal wave to be transmitted on wireless communication. The controller section 26 is incorporated as a known microcomputer or the like. The wireless section 24 and the controller section 26 have a function to serve as a transmitter.

As shown in FIG. 3, the base station 12 has an antenna 32 for transmission and reception of the radio wave. The base station 12 includes a wireless section 34 for transmission and reception of the radio wave via the antenna 32, a controller section 36, a position locating information detecting section 40, a communication state detecting section 42 and a timepiece 44, etc. The base station 12 includes a so-called microcomputer composed of a CPU, a Ram, a ROM, an input and output interface, etc. The CPU performs the signal processing in accordance with a program preliminarily stored in the ROM with utilizing a temporary storage function of the RAM, thereby performing those functions. In addition, the base station 12 is further provided with a communication interface 46.

Like the antenna 22 of the mobile station 10 set forth above, the antenna 32 is used for transmission and reception of the radio wave and employs an antenna with no directional characteristic. Like the wireless section 24 of the mobile station 10, the wireless section 34 serves to perform transmission and reception of the radio wave for the base station 12 and is switched by the controller section 36 into a transmitting state or a receiving state as will be described later. During transmission of the radio wave, the wireless section 34 transmits the radio wave through the antenna 32 associated there with depending on a control content commanded by the controller section 36, i.e., a content of a signal wave, a frequency of a carrier wave and a transmit output or the like. To this end, the wireless section 34 takes a structure including a carrier wave generating circuit, a demodulator and a transmission amplifier, etc. In addition, during reception of the radio wave, the wireless section 34 amplifies the radio wave received at the antenna 32 and executes given demodulation processing or the like for thereby extracting the signal wave. That is, the wireless section 34 is structured to also include a receiving amplifier and a demodulator, etc.

The controller section 36 serves to control the operation of the base station 12, and more particularly, it extracts the information at the wireless section 34, and processes information obtained by the server 14 (described below) and altering the operation of the base station 12 in response to a command. The controller section 36 controls the operation of the wireless section 34, i.e., more particularly, controls a transmit output and a transmit frequency, and generates the signal wave to be transmitted on a wireless communication. The controller section 36 is incorporated as a known microcomputer or the like.

The position locating information detecting section 40 detects position locating information, representing a result of received wave appearing when the wireless section 34 receives a position locating radio wave transmitted from the mobile station 10, which is used for a provisional position locating section 56 of the server 14 described below to locate the position of the mobile station 10. In the present embodiment, such position locating information is for instance a receiving intensity of the radio wave being received, for which for instance an RSSI (Receive Signal Strength Indication) representing for instance an index of the received radio wave with intensity being quantified in numerical terms is used. The position locating information detecting section 40 detects a value of such receiving intensity for instance for a receiving time period with a predetermined fixed time, and a resulting average thereof is used.

The communication state detecting section 42 detects an index representing a communication state of the radio wave when the wireless section 34 of the base station 12 receives the position locating radio wave transmitted from the mobile station 10. In the present embodiment, this index represents a receiving intensity of the radio wave being received, and includes for instance an RSSI detected at the position locating information detecting section 40. With such detection, the greater the RSSI indicative of the index representing the communication state of the radio wave is, the greater the intensity of the receiving radio wave becomes. That is, it can be estimated that the communication state remains in a favorable condition. Under a situation where the position locating information detecting section 40 and the communication state detecting section 42 detect the same object, the position locating information detecting section 40 and the communication state detecting section 42 have no need to be provided apart from each other and may be substantially the same. The index representing the communication state of the radio wave corresponds to a communication quality index.

The timepiece 44 supplies the controller section 36 with time information. The controller section 36 is operable to detect position locating information detected by the position locating information detecting section 40, and detect the index representing the communication state detected by the communication state detecting section 42 for each time. The communication interface 46 allows the base station 12 to transmit information to and receive the same from the server 14 and other base stations 12 via the communication cable 18. For instance, position locating information available to be detected by the position locating information detecting section 40, and the index indicative of the communication state detected by the communication state detecting section 42, are transmitted from the respective base stations 12 to the server 14 via the communication cable 18. In addition, the server 14 transmits a command related to the operations of the base station 12 and the mobile station 10 to the base stations 12, which is received though the communication interface 46.

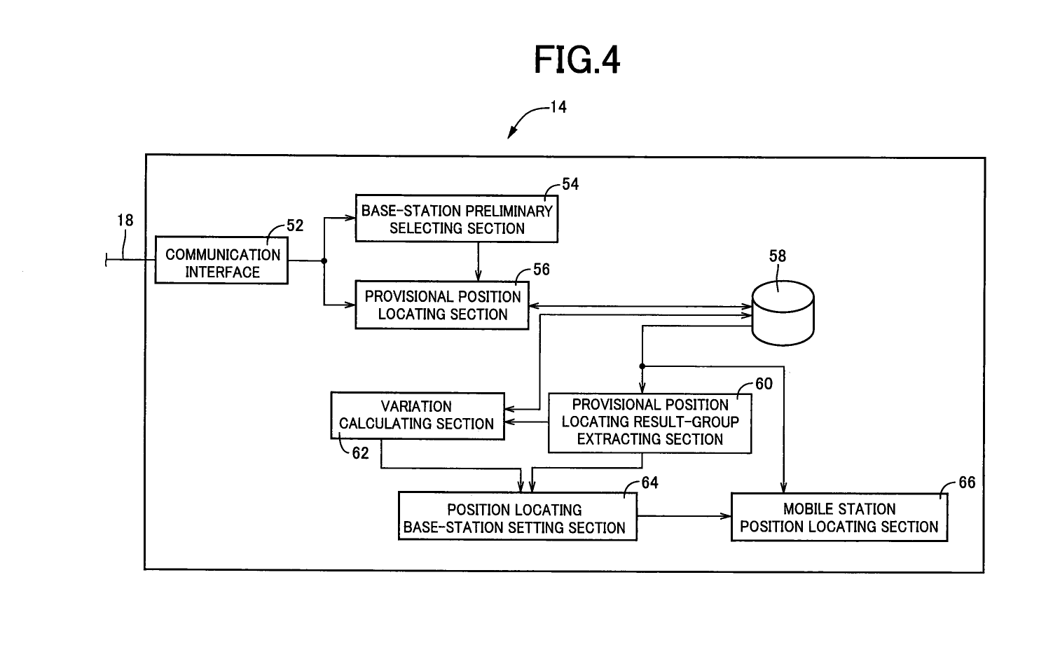

As shown in FIG. 4, the server 14 functionally includes a storage section 58 for storing requisite information, a base-station preliminary selecting section 54, the provisional position locating section 56, a provisional position locating result-group extracting section 60, a variation calculating section 62, a position locating base-station setting section 64, a mobile station position locating section 66 and a communication interface 52, etc. The server 14 takes the form of a structure including a so-called microcomputer composed of a CPU, a RAM, a ROM, an input and output interface, etc. The CPU performs signal processing in accordance with a program preliminarily stored in the ROM with utilizing a temporary storage function of the RAM, thereby executing required calculation.

Like the communication interface 46 of the base station 12 described above, the communication interface 52 serves to transmit information to and receive the same from the base stations 12 via the communication cable 18. More particularly, the server 14 serves to transmit information to and receive the same from the base stations 12. For instance, the communication interface 52 transmits a command to the base stations 12 for controlling the operations thereof, and receives position information available to be detected by the position locating information detecting section 40 of the base station 12, and the indices each indicative of the communications state available to be detected by the communication state detecting section 42, from the base stations 12.

The base-station preliminary selecting section 54 selects, based on the index indicative of the communication state available to be detected by the communication state detecting section 42 of each base station 12, among the base stations 12 constituting the mobile station position locating system 8, the base stations 12 for use in calculating the position of the mobile station 10. In the present embodiment, the index indicative of the communication state available to be detected by the communication state detecting section 42, is the RSSI representing receiving intensity of the position locating radio wave transmitted from the mobile station 10 upon receipt thereof. The base-station preliminary selecting section 54 selects only one base station 12 whose RSSI exceeds a predetermined threshold value, among the base stations 12 involved in the mobile station position locating system 8. The threshold value is preliminarily determined on experimental tests or set to a value obtained on simulation, so that error upon locating the position of the mobile station 10 falls within an allowable range.

The provisional position locating section 56 locates the position of the mobile station 10 using the base stations 12 selected by the base-station preliminary selecting section 54. More particularly, the provisional position locating section 56 sets a plurality of base station sets representing combinations of a predetermined given number of base stations based on the base stations 12 selected by the base-station preliminary selecting section 54. Then, the provisional position locating section 56 locates the position of the mobile station 10 based on position locating information detected by the communication state detecting sections 42 of the base stations 12 forming the base station sets, for each of the plurality of base station sets being set. Information on a calculated position of the mobile station 10 is stored in the storage section 58 together with information on the base station sets used for the calculations.

Detailed description will be provided with reference to an example of the mobile station position locating system 8 of the present embodiment shown in FIG. 1. The mobile station position locating system 8 has a structure including the first to seventh base stations 12A to 12G. The mobile station 10 transmits the position locating radio wave, which is received by the wireless sections 34 of the respective base stations 12. Then, the communication state detecting sections 42 of the respective base stations 12 detect the RSSI representing the communicating state of the radio wave. The base-station preliminary selecting section 54 of the server 14 selects five base stations including for instance the base stations 12A to 12E as the base stations 12 with each RSSI exceeding the predetermined threshold value.

During the movement of the mobile station 10 on a flat plane, the provisional position locating section 56 allows the given number of base stations 12 used for calculating the position of the mobile station 10 to be set to “3”. Accordingly, the provisional position locating section 56 sets the base station set composed of three base stations selecting among the five base stations including the first to fifth base stations 12A to 12E selected by the base-station preliminary selecting section 54. For the base station set being set, the provisional position locating section 56 determines 10 sets of base station sets including: a base station set (hereinafter referred to as a “base station set (1, 2, 3)”) composed of the first to third base stations 12A to 12C; a base station set (hereinafter referred to as a “base station set (1, 2, 4)”) composed of the first base station 12A, the second base station 128 and the fourth base station 12D; a base station set (hereinafter referred to as a “base station set (1, 2, 5)”) composed of the first base station 12A, the second base station 12B and the fifth base station 12E; a base station set (hereinafter referred to as a “base station set (1, 3, 4)”) composed of the first base station 12A, the third base station 12C and the fourth base station 12D; a base station set (hereinafter referred to as a “base station set (1, 3, 5)”) composed of the first base station 12A, the third base station 12C and the fifth base station 12E; a base station set (hereinafter referred to as a “base station set (1, 4, 5)”) composed of the first base station 12A, the fourth base station 12D and the fifth base station 12E; a base station set (hereinafter referred to as a “base station set (2, 3, 4)”) composed of the second base station 12B, the third base station 12C and the fourth base station 12D; a base station set (hereinafter referred to as a “base station set (2, 3, 5)”) composed of the second base station 12B, the third base station 12C and the fifth base station 12E; a base station set (hereinafter referred to as a “base station set (2, 4, 5)”) composed of the second base station 12B, the fourth base station 12D and the fifth base station 12E; and a base station set (hereinafter referred to as a “base station set (3, 4, 5)”) composed of the third base station 12C, the fourth base station 12D and the fifth base station 12E.

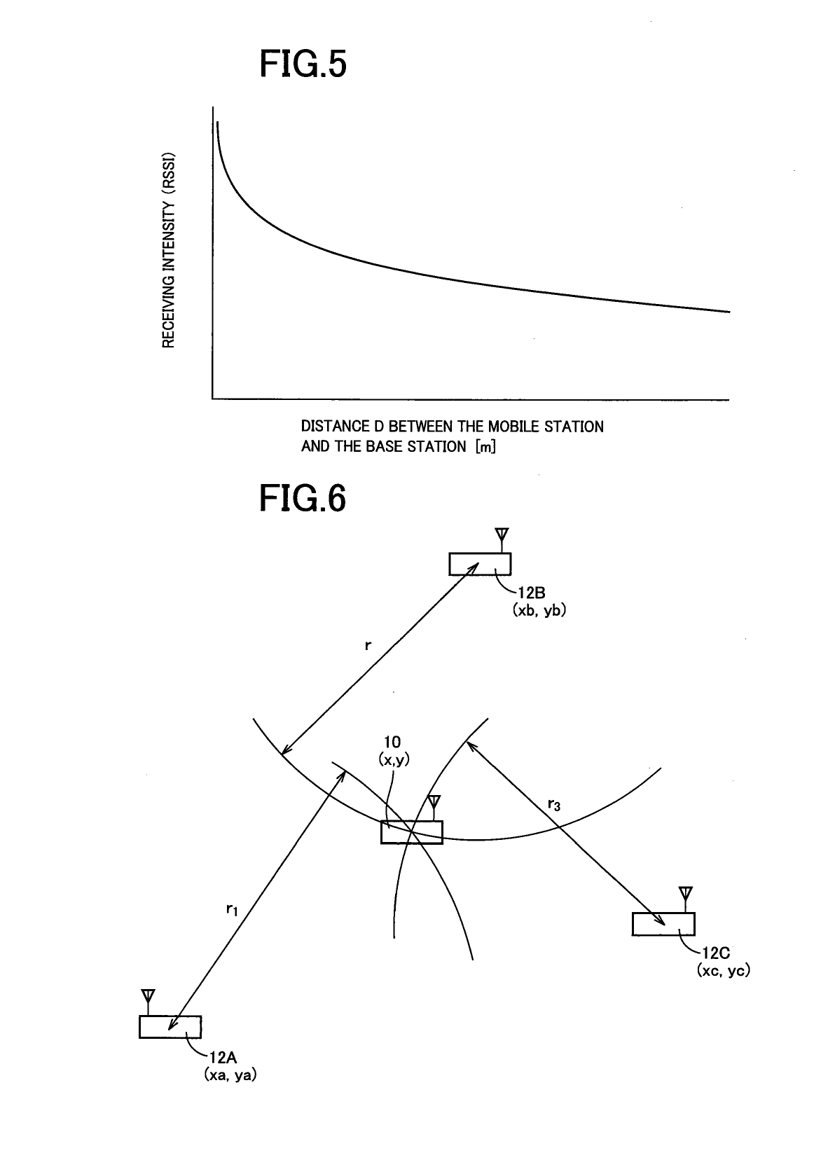

Subsequently, the provisional position locating section 56 locates the position of the mobile station 10 based on position locating information detected by the position locating information detecting sections 40 of the base stations 12 forming the base station sets for the respective base station sets which are set. As set forth above, in the present embodiment, position locating information to be detected by the position locating information detecting sections 40 is receiving intensity (RSSI) of the position locating radio wave transmitted from the mobile station 10. Receiving intensity of the received radio wave transmitted with a given output, and a propagation distance D of the radio wave, i.e., a distance between the mobile station 10 and the base station 12 have the one-on-one relationship as shown in FIG. 5. Preliminarily storing such a relationship in the storage section 58 as shown in FIG. 5, compels the RSSI transmitted from the respective base stations 12 for representing position locating information to be converted to the distance between the respective base stations 12 and the mobile station 10. In such a way, the provisional position locating section 56 calculates the distance between the respective base stations 12 forming the base station sets, and the mobile station 10.

Consecutively, the provisional position locating section 56 locates the position of the mobile station 10 based on the distance between the respective base stations 12 forming the calculated base station sets and the mobile station 10, and information preliminarily known and related to the positions of the respective base stations 12 stored in for instance the storage section 58. A process for locating the position of the mobile station 10 using the base station set (1, 2, 3) by the provisional position locating section 56 will be explained with reference to FIG. 6.

As shown in FIG. 6 illustrating a principle of the operation to be performed by the provisional position locating section 56 to locate the position of the mobile station 10, suppose the position of the mobile station 10 lies at the coordinate (x, y); the position of the first base station 12A at the coordinate (xa, ya); the position of the second be station 12B at the coordinate (xb, yb); and the position of the third base station 12C at the coordinate (xc, yc). These relationships are obtained by equations expressed below. In addition, the position of the base station 12 shown in FIG. 6 is slightly different from that shown in FIG. 1.

(xa−x)²+(ya−y)²=r1²

(xb−x)²+(yb−y)²=r2²

(xc−x)²+(yc−y)²=r3² (1)

where r1, r2 and r3 (m) represents distances between the first to third base stations 12A to 12C and the mobile station 10, respectively, to indicate values obtained based on the RSSI indicative of position locating information, and the relationship shown in FIG. 5. The provisional position locating section 56 solves the equation (1) mentioned above for thereby calculating the position (x, y) of the mobile station 10. Thus, when locating the position of the mobile station 10 based on the position of the mobile station 10, and the distance between the base station and the mobile station 10, if the equation (1) includes more than three equations, then, the position of the mobile station 10 can be located. That is, at least more than three base stations 12 may suffice to receive the position locating radio waves transmitted from the mobile station 10. Therefore, in the present embodiment, the base station set include or is constituted of the three base stations.

The position of the mobile station 10 located by the provisional position locating section 56 is stored in the storage section 58, together with information on the base station set used in such calculation. In the following description, the position of the mobile station 10 located by the provisional position locating section 56 using the base station set (a, b, c) is represented as a provisional position locating result S (a, b, c), which will be referred to as a provisional position locating result associated with the base station set (a, b, c).

Turning back to FIG. 4, among the provisional position locating results associated with the respective base station sets calculated by the provisional position locating section 56, the provisional position locating results, associated with the plural base station sets with no inclusion of the specified base station, are extracted by the provisional position locating result-group extracting section 60 as a provisional position locating result group. In the present embodiment, the provisional position locating section 56 sets the ten sets of base station sets including the base station set (1, 2, 3), the base station set (1, 2, 4), the base station set (1, 2, 5), the base station set (1, 3, 4), the base station set (1, 3, 5), the base station set (1, 4, 5), the base station set (2, 3, 4), the base station set (2, 3, 5), the base station set (2, 4, 5) and the base station set (3, 4, 5). With the first base station 12A assigned to the specified base station mentioned above for instance the base station sets, which do not involve the first base station 12A assigned to the specified base station, include the base station set (2, 3, 4), the base station set (2, 3, 5), the base station set (2, 4, 5) and the base station set (3, 4, 5). These base station sets are associated with the provisional position locating results S (2, 3, 4), S (2, 3, 5), S (2, 4, 5) and S (3, 4, 5), which are extracted as the provisional position locating result groups, respectively. Likewise, with the second base station 12B assigned to the specified base station for instance the provisional position locating results S (1, 3, 4), S (1, 3, 5), S (1, 4, 5) and S (3, 4, 5) are extracted as the provisional position locating result group. With the third base station 12C assigned to the specified base station for instance the provisional position locating results S (1, 2, 4), S (1, 2, 5), S (1, 4, 5) and S (2, 4, 5) are extracted as the provisional position locating result groups, respectively. With the fourth base station 12D assigned to the specified base station for instance the provisional position locating results S (1, 2, 3), S (1, 2, 5), S (1, 3, 5) and S (2, 3, 5) are extracted as the provisional position locating result groups, respectively. With the fifth base station 12E assigned to the specified base station for instance the provisional position locating results S (1, 2, 3), S (1, 2, 4), S (1, 3, 4) and S (2, 3, 4) are extracted as the provisional position locating result groups, respectively.

The variation calculating section 62 calculates variations of the provisional position locating result groups, when the respective base stations 12 extracted by the provisional position locating result group extracting section 60 are assigned to the specified base stations. Each of such variations is an index representing the distribution degree of the provisional position locating result contained in the provisional position locating result group. In the present embodiment, a variation σ is defined in the following equation (2) as a standard deviation of the coordinates of the provisional position locating result contained in the provisional position locating result group.

σ=\sqrt{σx²+σy²} (2)

where σx represents a standard deviation of a coordinate in an X-direction of the each provisional position locating result contained in the provisional position locating result group, and σy represents a standard deviation of a coordinate in a Y-direction of the each provisional position locating result contained in the provisional position locating result group, both of which are indicated by equations (3) expressed as:

$${σ}_{x}^{2} = \frac{1}{N} {\sum }_{i = 1}^{N} {( {x}_{i} - {x}_{AV} )}^{2} \\ {σ}_{y}^{2} = \frac{1}{N} {\sum }_{i = 1}^{N} {( {y}_{i} - {y}_{AV} )}^{2} \qquad ( 3 )$$

In equations (3), the suffix “i” represents each provisional position locating result contained in the provisional position locating result group, and N represents a total number of the provisional position locating results contained in the provisional position locating result groups. In equations (3), further, “x_{AV}” represents an average of the coordinates in the X-direction of the provisional position locating results contained in the provisional position locating result groups, and “y_{AV}” represents an average of the coordinates in the Y-direction of the provisional position locating results contained in the provisional position locating result groups. More particularly, these are indicated by equations (4) expressed as:

$${x}_{AV} = \frac{1}{N} {\sum }_{i = 1}^{N} {x}_{i} \\ {y}_{AV} = \frac{1}{N} {\sum }_{i = 1}^{N} {y}_{i} \qquad ( 4 )$$

The variation calculating section 62 calculates such that: a variation of the provisional position locating result group with the first base station 12A assigned to the specified base station is σ1; a variation of the provisional position locating result group with the second be station 12B assigned to the specified base station is σ2; a variation of the provisional position locating result group with the third base station 12C assigned to the specified base station is σ3; a variation of the provisional position locating result group with the fourth base station 12D assigned to the specified base station is σ4; and a variation of the provisional position locating result group with the fifth base station 12E assigned to the specified base station is σ5.

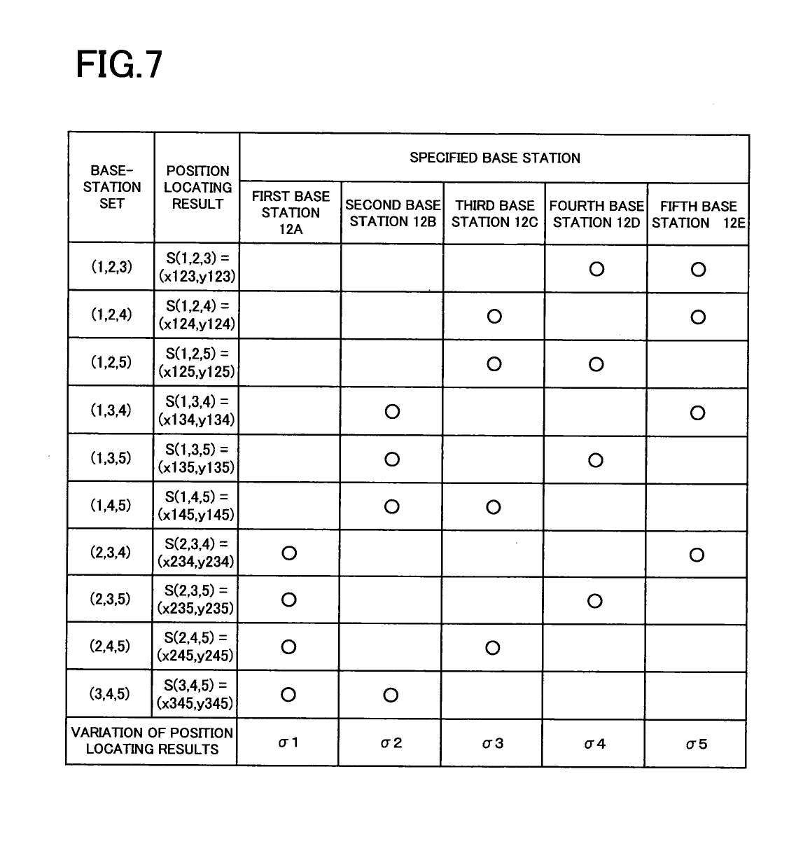

In FIG. 7, a first row indicates the base station set which the provisional position locating section 56 has determined, and a second row indicates the provisional position locating result associated with the base station set of the first row. Third to seventh rows indicate the base stations forming the provisional position locating result groups with the first to fifth base stations 12A to 12E assigned to the specified base stations, respectively. The provisional position locating result groups corresponding to the respective rows are constituted by the provisional position locating result groups described in the second row by lines added with round marks.

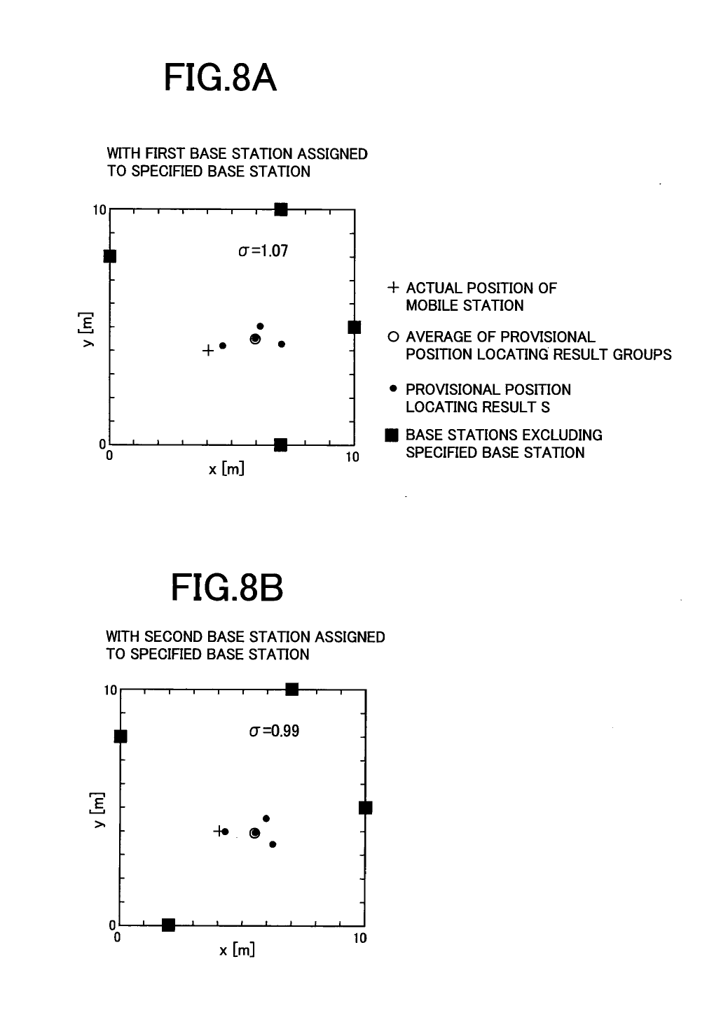

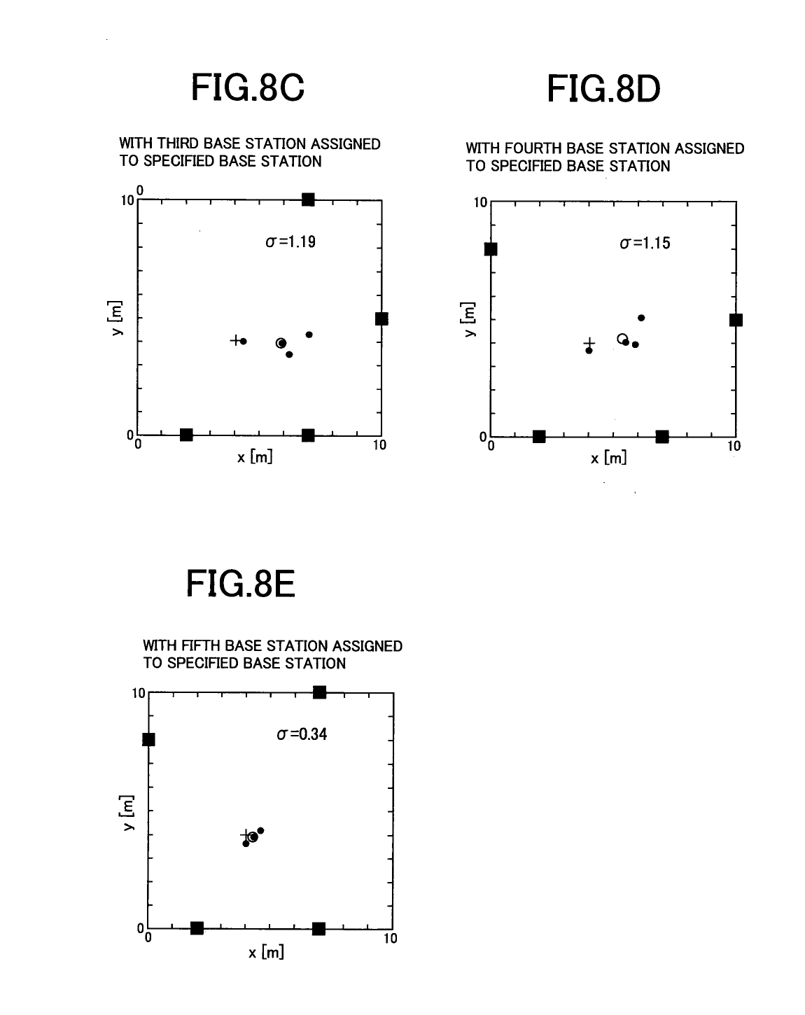

FIGS. 8A to 8E show simulation results representing examples of the provisional position locating result groups and the variations thereof when the first to fifth base stations 12A to 12E are assigned to the specified base stations. In this simulation, the first base station 12A has a position indicated at (2 (m), 0 (m)); the second base station 1B has a position at (7, 0); the third base station 1C has a position at (7, 0); the fourth base station 1D has a position at (7, 10); and the fifth base station 1E has a position at (10, 5); and the mobile station 10 has a position at (4, 4). In addition, variation values in measuring distance errors of the respective base stations 12 are assigned to have a value of 0.5 for the first to fourth base stations 12A to 12D, and a value of −3 for the fifth base station 12E. Each of such variations represents a deviation between an average of distances appearing between the mobile station 10 and each of the base stations 12 calculated based on relevant intensity by the position locating radio wave transmitted from the mobile station 10 to be received at each of the base stations 12, and a true value. A large variation represents that the calculation is likely to be subjected to interference caused by the jamming waves or the multipath in the presence of a jamming-wave transmission source located in the vicinity of the base station having the large variation, or in a position of the base station susceptible to an affect of a reflected wave.

FIGS. 8A to 8E are views corresponding to cases with the first to fifth base stations being assigned to the specified base stations, respectively. In respective views, black squared plots represent the base stations 12 excluding or except for the specified base stations. That is, the base stations 12 placed in areas plotted in black squares set the base station set, which in turn is used for the provisional position locating section 56 to provisionally locate the position of the mobile station 10. In each of FIGS. 8A to 8E, moreover, black circles represent the provisional position locating results obtained using respective ones of the base station sets being set, respectively. That is, in each of FIGS. 8A to 8E, an aggregated mass of dots indicated by multiple black circles, corresponds to each of the provisional position locating result groups. More particularly, for instance in FIG. 8A wherein the first base station 12A is assigned to the specified base station, the black squared plots represent the second to fifth base stations serving as the base stations excluding the specified base station. The black circle plots represent the provisional position locating results S (2, 3, 4), S (2, 3, 5), S (2, 4, 5) and S (3, 4, 5) associated with the base station sets (2, 3, 4), (2, 3, 5), (2, 4, 5) and (3, 4, 5), respectively. In each of FIGS. 8A to 8E, a white circle plot represents an average (x_{AV}, y_{AV}) of the provisional position locating result groups calculated when the variation calculating section 62 calculates the value of the standard deviation σ as the variation, and a plot in a plus (+) mark represents an actual position of the mobile station 10.

The variations σ calculated by the variation calculating section 62 are indicated as σ1=1.07 in FIG. 8A with the first base station 12A being assigned to the specified base station; σ2=0.99 in FIG. 8B with the second base station 12B being assigned to the specified base station; σ3=1.19 in FIG. 8C with the third base station 12C being assigned to the specified base station; σ4=1.15 in FIG. 8D with the fourth base station 12D being assigned to the specified base station; and σ5=0.34 in FIG. 8E with the fifth base station 12E being assigned to the specified base station.

Turning back to FIG. 4, the variation calculating section 62 calculates the respective variations of the provisional position locating results. On calculating the variation σ with the least value among the provisional position locating result groups with the variations σ calculated by the variation calculating section 62, the position locating base-station setting section 64 sets the position locating base station excluding the base station assigned to the specified base station. In the present embodiment, the values of the variations σ1 to σ5 calculated by the variation calculating section 62 are compared to select a variation with the least value. Then, when extracting the provisional position locating result group corresponding to the selected variation with the least value, the position locating base station is set excluding the specified base station. That is, among the base stations selected by the base-station preliminary selecting section 54, the base station is set with no specified base stations, for the position locating base station.

In the illustrated examples shown in FIGS. 8A to 8E, among the variations σ1 to σ5, the variation σ5 has the least value. The provisional position locating result group, associated with the variation σ5, includes the provisional position locating result group when the fifth base station 12E is assigned to the specified base station. Accordingly, among the first to fifth base stations 12A to 12E representing the base stations selected by the base-station preliminary selecting section 54, the base stations excluding the fifth base station 12E assigned to the selected specified base station, i.e., the first to fourth base stations 12A to 12D, are set by the base-station preliminary selecting section 54 to be the position locating base stations. With such a simulation example, further, the variation σ5, when the fifth base station 12E having the large variation in the measuring distance errors is assigned to the specified base station has the least value, which means a simulation result is reasonable. In the relationships between the variations σ and the provisional position locating result groups, moreover, the smaller the variation σ is, the less the distance between an actual position of the mobile station 10 and the average (x_{AV}, y_{AV}) of the provisional position locating result groups becomes. Therefore, selecting the specified base station so as to minimize the variation σ allows the base stations, except for the specified base station, to serve as the position locating base stations for locating the position of the mobile station 10, thereby increasing precision of the position locating.

In the position locating base-station setting section 64, there exist the base station that is not assigned to the position locating base station, among the base stations selected by the base-station preliminary selecting section 54. Therefore, the position locating base-station setting section 64 stores the number of times the base station is excluded from the position locating base stations for each of the base stations in each time the base stations are set as the position locating base stations. In particular, if the variation σ5 has the least value as set forth above, the position locating base-station setting section 64 sets the base stations, except for the fifth base station 12E set as the specified base station, i.e., the first to fourth base stations 12A to 12D, as the position locating base stations. In addition, the position locating base-station setting section 64 adds the number of times for the fifth base station 12E excluded from the position locating base stations by one time.

Among variations σ of the provisional position locating result groups calculated by the variation calculating section 62, in a case where there exist plural variations σ with the least values, the position locating base-station setting section 64 sets the position locating base stations in a manner described below. As used herein, the “case where there exist plural variations σ with the least values” is not limited to a case under which there are plural equalized variations σ representing the least values, but includes a case under which besides the variations σ having the least value, another variation with a value is included falling in a given range on consideration of the measuring error in the provisional position locating section 56. Under such cases, the position locating base-station setting section 64 extracts the base stations regarded to be the specified base stations, for the provisional position locating result groups containing the plural variations σ with the least values, respectively. Then, for each of the base stations regarded to be the specified base stations, the number of times the base stations excluded from the position locating base stations and counted by the position locating base-station setting section 64, are compared. Among the base stations regarded to be the specified base stations in association with the plural variations σ with the least values, the position locating base-station setting section 64 sets the position locating base stations, except for the base stations excluded from the position locating base stations in a large number of times.

A concrete example will be described below with reference to a case in which the values of the variations σ1 to σ5 calculated by the variation calculating section 62 are compared and the variations σ1 and σ2 are targets with the least values. In this case, the provisional position locating result groups related to the plural variations σ1 and σ2 with the least values correspond to the provisional position locating result groups appearing when the first and second base stations 12A and 12B are assigned to the specified base stations. Thus, the position locating base-station setting section 64 compares the number of times the first and second base stations 12A and 12B are excluded from the position locating base stations to each other in time. There is likelihood that the number of time the first base stations 12A is excluded from the position locating base stations is greater than the number of time the second base station 12B is excluded from the position locating base station. With such likelihood, among the first to fifth base stations 12A to 12E corresponding to the base stations selected by the base-station preliminary selecting section 54, the base stations excluding the first base station 12A, i.e., the second to fifth base stations 1213 to 12E are assigned to the position locating base stations. A setting method of the position locating base stations in the mobile station position locating system 8 including the position locating base-station setting section 64, corresponds to a position locating base-station selecting method of the present invention. Accordingly, the mobile station position locating system 8 involves the position locating base station selecting system 9.

Turning back to FIG. 4, the mobile station position locating section 66 locates the position of the mobile station 10 based on the provisional position locating results obtained by the position locating base stations set by the position locating base-station setting section 64. More particularly, the mobile station position locating section 66 calculates an average of the provisional position locating results obtained by the provisional position locating section 56. This calculation is made using the provisional position locating results of the base station sets constituted by the respective base stations regarded to be the position locating base stations set by the position locating base-station setting section 64, upon which the average is assigned to the position of the mobile station 10.

More particularly, further, as set forth above, there is likelihood that the position locating base-station setting section 64 assigns the fifth base station 12E to the specified base station, and the base stations with no inclusion of the fifth base station 12E, i.e., the first to fourth base stations 12A to 12D are determined to the position locating base stations. With such likelihood, the provisional position locating result groups including the provisional position locating results S (1, 2, 3), S (1, 2, 4), S (1, 3, 4) and S (2, 3, 4) calculated by the provisional position locating section 56 on the base station set (1, 2, 3), the base station set (1, 2, 4), the base station set (1, 3, 4) and the base station set (2, 3, 4) are retrieved by the storage section 58, respectively. Then, an average (x_{AV}, y_{AV}) of the provisional position locating result groups is calculated to be the position of the mobile station 10.

With the present embodiment, on calculating the variations σ being assigned to the specified base stations at the respective base stations 12, respectively, the variation calculating section 62 calculates the average (x_{AV}, y_{AV}) of the provisional position locating result groups. This allows the storage section 58 to store the average (x_{AV}, y_{AV}) of the provisional position locating result groups that are calculated by the variation calculating section 62 during a calculating process of the variations σ. Then, the mobile station position locating section 66 can select to read out the average (x_{AV}, y_{AV}) of the provisional position locating result groups from the storage section 58 related to the position locating base stations determined by the position locating base-station setting section 64, from the average (x_{AV}, y_{AV}) of the provisional position locating result groups stored in the storage section 58. By so doing, no need arises for the average (x_{AV}, y_{AV}) of the provisional position locating result groups to be newly obtained, reducing the calculation amount with decrease in electric power consumption and less time required for the position locating. A method of locating the position of the mobile station 10 in the mobile station position locating system 8 corresponds to a mobile station position locating method of the present invention.

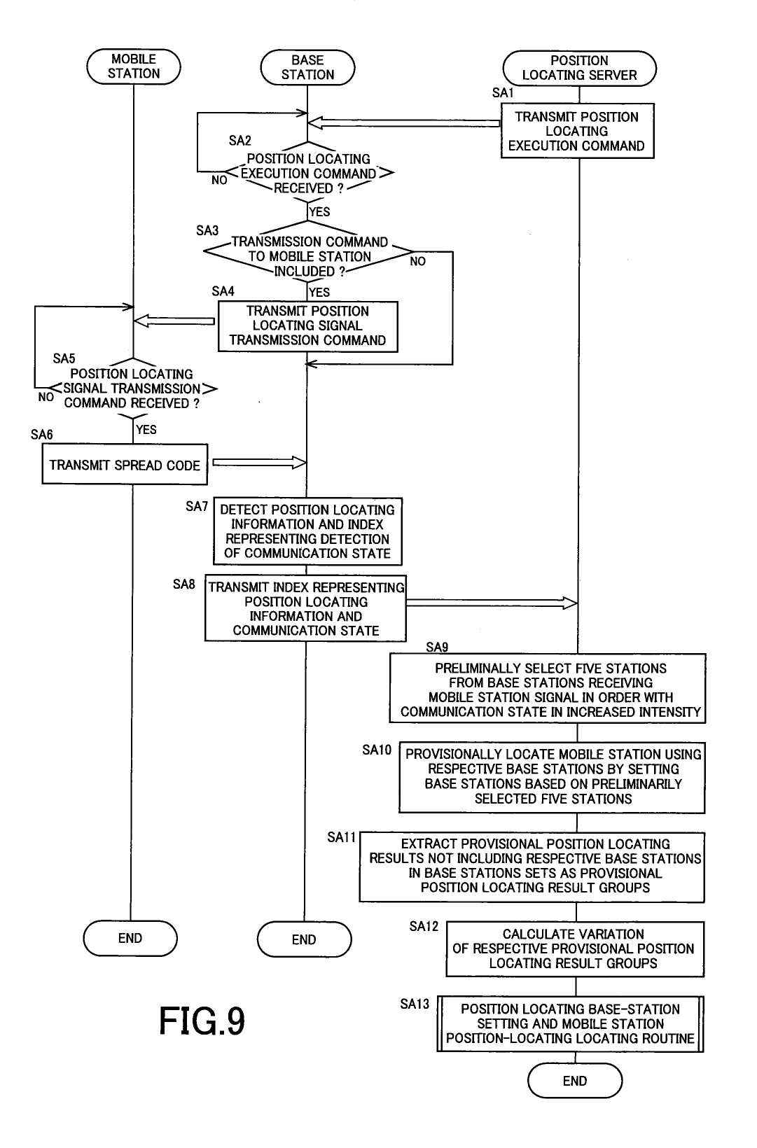

FIG. 9 is a flowchart illustrating one example of a sequence of control operations to be executed by the mobile station position locating system 8 of the present embodiment. First, at step (hereinafter, the term “step” will be omitted) SA1, the server 14 transmits commands to the base stations 12 respectively, for locating the position of the mobile station 10. These commands include: (1) a command that commands one (hereinafter referred to as a “representative base station”) of the plural base stations 12 to transmit a radio wave via the wireless section 34 of the relevant base station 12 to the mobile station 10 for locating the position thereof; and (2) a command that commands the plural base stations 12 to receive the position locating radio wave transmitted from the mobile station 10 for allowing the position locating information detecting section 40 to measure position locating information, and compels the communication state detecting section 42 to detect the indices indicative of the communication states between the mobile station 10 and the respective base stations 12. Of these, the command (1) is generated due to the fact that the server 14 has no function of transmitting and receiving the radio wave on wireless communication, and hence the command from the server 14 to the mobile station 10 is initiated by the wireless section 34 of one of the base stations 12. The representative base station, serving as one of the base stations 12 mentioned above, is assigned to the base station 12 that is arbitrarily selected.

At SA2, a query is made as to whether the respective base stations 12 receive the command from the server 14 at SA1. Upon receipt of such a command from the server 14 at SA1, the answer to the query at the current step is yes, and succeeding step SA3 is executed. On the contrary, if no command is received from the server 14 at SA1, then, the answer to the query is no, and step SA1 is repeatedly executed until the command at SA1 is received from the server 14.

SA3 represents a step that is executed when the answer to SA2 is yes and a query is made as to whether the command (1) is received from the server 14 received at SA2. The answer to the current step is yes in the base station 12, in which the command (1) is received, i.e., the representative base station, upon which SA4 is executed. Further, the answer to the current step is no in the base station 12 in which no command (1) is received but only the command (2) is received. In this moment, no SA4 is executed and the position locating radio wave transmitted from the mobile station 10 is received.

At SA4, the command is transmitted to the mobile station 10 on wireless communication to compel the mobile station 10 to transmit the position locating radio wave. After the command has been set to the mobile station 10, the position locating radio wave transmitted from the mobile station 10 is received.

At SA5, a query is made as to whether the mobile station 10 receives the command (the command at SA4) for transmitting the position locating radio wave. If the mobile station 10 receives such a command for transmitting the position locating radio wave, then, the answer to current step is yes, and succeeding SA6 is executed. In contrast, if no command for transmitting the position locating radio wave is received, then, the answer to current step is no, and SA5 is repeatedly executed until the command for transmitting the position locating radio wave is received.

At SA6 corresponding to the wireless section 24, etc., of the mobile station 10, the mobile station 10 transmits the position locating radio wave, which is initiated in the form of a predetermined output.

At SA7 corresponding to the wireless section 34, the position locating information detecting section 40 and the communication state detecting section 42, of the respective base stations 12, the position locating radio wave transmitted from the mobile station 10 is received, and for a result of received wave, a value of position locating information which is the value for use in the position-locating is detected. In addition, an index indicative of a communication state of the radio wave is detected between the mobile station 10 that transmits the position locating radio wave, and the base stations 12 that receive the radio wave. With the present embodiment, position locating information is the RSSI indicative of intensity of the radio wave being received, and in addition, the index indicative of the communication state of the radio wave is the RSSI representing intensity of the radio wave being received. For this reason, RSSI is detected.

At SA8 corresponding to the communication interface 46 or the like, position locating information, and information related to the index representing the communication state of the radio wave both detected at SA7, are transmitted to the server 14 via the communication cable 18 or the like.

At SA9 corresponding to the base-station preliminary selecting section 54 of the server 14, the base stations for use in provisional position-locating are selected. This selection is made based on the index representing the communication state of the radio wave between the mobile station 10 that transmits the position locating radio wave, and the base stations 12 that receives the radio wave with the index both detected by the base stations 12 at SA7. The selection of the base stations for use in provisional position-locating at current step is made by selecting the base stations in which the index representing the communication state of the radio wave exceeds the predetermined threshold value.

At SA10 corresponding to the provisional position locating section 56, among the base stations selected at SA9, plural base station sets, representing a combination of three base stations which is a given predetermined number are set. Then, the position of the mobile station 10 is located, i.e., the provisional position-locating is performed using the respective base station sets being set. In particular, the position of the mobile station 10 is located based on position locating information detected at SA7 by the base stations 12 forming the base station sets, and information on the positions of the respective base stations 12 that are known in advance. With the present embodiment, more particularly, position locating information detected at SA7 is receiving intensity of the radio wave transmitted from the mobile station 10 in the form of a given output. Thus, depending on the relationship (shown for instance in FIG. 5) between preliminarily stored receiving intensity and a propagation distance of the radio wave, distances between the respective base stations 12 and the mobile station 10 can be calculated, respectively. Subsequently, solving the equation (1) to which the calculated value is applied results in a consequence in which the position of the mobile station 10 is located (in provisional position-locating). This provisional position-locating is executed for all of the base station sets that are formed of the base stations selected at SA9. For instance, at SA10, the five base stations are selected including the first to fifth base stations 12A to 12E. At current step, ten sets of the base station sets are set as the base station set (1, 2, 3), the base station set (1, 2, 4), the base station set (1, 2, 5), the base station set (1, 3, 4), the base station set (1, 3, 5), the base station set (1, 4, 5), the base station set (2, 3, 4), the base station set (2, 3, 5), the base station set (2, 4, 5) and the base station set (3, 4, 5). The provisional position-locating is performed using these base station sets. Moreover, as set forth above, the base station set (1, 2, 3) represents the base station set comprised of the first to third base stations 12A to 12C. This similarly applies to the other base station sets.

At SA11 corresponding to the provisional position locating result-group extracting section 60, among the provisional position locating results associated with the base station sets calculated at SA10, the provisional position locating results, associated with the plural base station sets which do not include any specified base station, are extracted as the provisional position locating result groups. In a case wherein for instance the provisional position locating results are calculated for the respective ten sets of the base station sets at SA10, the first base station 12A is assigned to the specified base station. In such a case, the base station sets, which do not involve the first base station 12A serving as the specified base station, are extracted as the provisional position locating result groups such as the provisional position locating results S (2, 3, 4), S (2, 3, 5), S (2, 4, 5) and S (3, 4, 5) associated with the base station set (2, 3, 4), the base station set (2, 3, 5), the base station set (2, 4, 5) and the base station set (3, 4, 5), respectively.

At SA12 corresponding to the variation calculating section 62, the respective variations of the provisional position locating result groups are calculated appearing when the base stations extracted at SA11 are assigned to the specified base stations. These variations represent the indices each representing the distribution degree of the provisional position locating results included in the provisional position locating result groups, and in the present embodiment, include standard deviations of the respective provisional position locating results forming the provisional position locating result groups. For instance, the variations σ1 to σ5 are calculated for the provisional position locating result groups extracted at SA 11, respectively, under a circumstance where the first to fifth base stations 12A to 12E are assigned to the specified base stations at SA11.

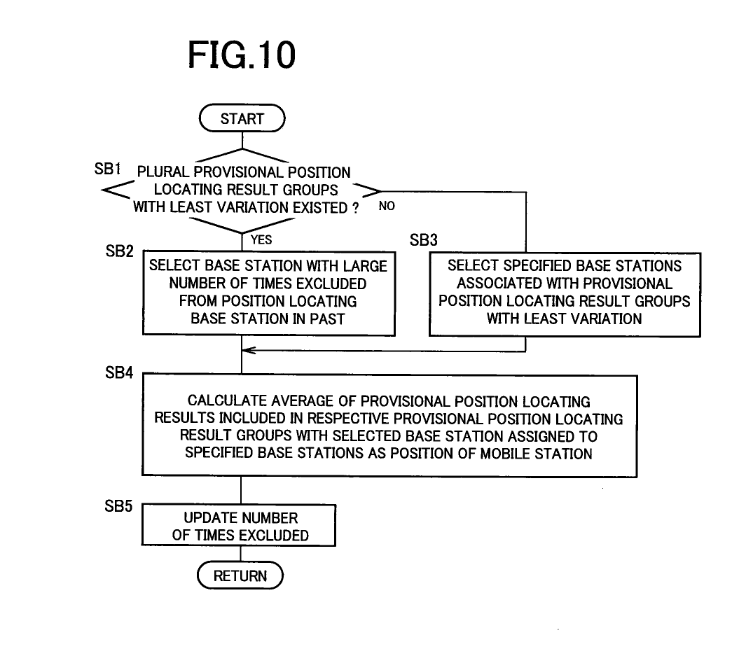

At SA13, a position locating base station setting and mobile station position-locating locating routine, corresponding to both the position locating base-station setting section 64 and the mobile station position locating section 66, are executed. FIG. 10 shows a flowchart illustrating one example of a sequence of control operations performed in such a position locating base station setting and mobile station position-locating locating routine.

SB1 to SB3 corresponds to the position locating base-station setting section 64. First, at SB1, the variations σ of the provisional position locating result groups occurring when the respective base stations 12 calculated at SA12, are assigned to the specified base stations, are compared to each other, upon which a query is made as to whether the plural variations σ having the least values are present. The expression “the plural variations σ having the least values are present” is not limited to a situation under which there exist plural variations σ having equal values with the least values, but may include a case under which in addition to the variation σ having the least value the variation σ is present within a predetermined or given range. If there are plural variations σ each having the least value, the answer to the query at current step is yes, and SB2 is executed. Moreover, if there is one variation σ having the least value, the answer to the query at current step is no, and SB3 is executed.

SB2 is a step that is executed when there are the plural variations σ each having the least value. At current step, the base stations assigned to the specified base stations, are extracted for the respective provisional position locating result groups in which the plural variations σ each having the least value are calculated, respectively. Then, by executing the routines shown in the flowcharts of FIGS. 9 and 10, for the respective base stations assigned to the specified base stations, the number of times the base stations are excluded from the position locating base stations are compared when the position locating base stations are repeatedly determined. Among the base stations assigned to the specified base stations in association to the plural variations σ with the least values, the base stations of which number of times excluded from the position locating base stations in large, are selected to be the base stations disenabled to serve as the position locating base stations.

Meanwhile, SB3 is a step that is executed when there is one variation σ with the least value determined at SB1. At current step, for the provisional position locating result group in which the variation σ regarded to have the least value determined at SB1 is calculated, the base station assigned to the specified base station, is selected to be the base stations excluded from the position locating base stations.

At SB2 and SB3, the base stations regarded not to serve as the position locating base stations are selected. Among the base stations selected at SA9, the position locating base stations are assigned to the base stations from which the base stations selected at SB2 or SB3 are excluded. Thus, executing SB2 and 583 allows the position locating base stations to be substantially selected.

At SB4 corresponding to the mobile station position locating section 66, the average (x_{AV}, y_{AV}) of the provisional position locating results included in the provisional position locating result groups, when the base station 12 selected at either SB2 or SB3 is assigned to the specified base station, is calculated as the position of the mobile station 10.

At 585, for the base stations selected as the base stations disenabled to serve as the position locating base stations, the number of times excluded from the position locating base stations is updated. The number of times is used in determination at SB2.

With the mobile station position locating system 8 of the present embodiment set forth above, among the plural base stations 12, the provisional position locating section 56 sets the base station sets each in combination with the given number of base stations 12 less than the plural number of the base stations 12. Then, the position of the mobile station 10 is calculated using the determined base station sets. Among the provisional position locating results associated with the base station sets calculated by the provisional position locating section 56 for the respective base station sets, the provisional position locating result-group extracting section 60 extracts the provisional position locating results associated with the plural base station sets with no inclusion of the specified base stations in the base station sets, as the provisional position locating result groups. The provisional position locating result-group extracting section 60 allows the base stations 12 of at least part of the base stations 12 to be assigned to the specified base stations for obtaining provisional position locating result groups. The variation calculating section 62 calculates the variations σ of such provisional position locating result groups.

Among the respective variations σ of such provisional position locating result groups calculated by the variation calculating section 62, the provisional position locating result group with the variation σ in the least value is calculated, at which the position locating base-station setting section 64 sets the position locating base stations excluding the base stations 12 regarded to be the specified base stations. Then, the position of the mobile station 10 is calculated based on a position locating result obtained by using the base station sets formed of the position locating base stations which are set by the position locating base-station setting section 64. Thus, the base stations excluding the specified base station susceptible to interference caused by the jamming waves or the multipath, are selected as the position locating base stations for the base stations to be used in position-locating. Thus, the position of the mobile station 10 can be located using those position locating base stations.

With the present embodiment, further, the mobile station position locating section 66 calculates the average (x_{AV}, y_{AV}) of the provisional position locating result groups as the position of the mobile station 10. The provisional position locating result groups are obtained by the provisional position locating section 56 using the base station sets structured of the position locating base stations, which are set by the position locating base-station setting section 64. Thus, the base stations excluding the specified base stations susceptible to interference resulting from the jamming waves or the multipath is selected as the position locating base stations. Thus, the position of the mobile station 10 is located using those position locating base stations. That is, this can reduce an adverse affect in the position locating results caused by interference resulting from the jamming waves or the multipath.

With the present embodiment, furthermore, the variation calculating section 62 calculates the standard deviation of the provisional position locating result groups as the variation σ. The greater the error in the provisional position locating results is, the variation increases. Therefore, the position locating base-station setting section 64 sets the position locating base stations. Thus, the base stations excluding the specified base stations that are susceptible to interference resulting from the jamming waves or the multipath is selected as the position locating base stations. This enables the position of the mobile station 10 to be located using those position locating base stations. That is, this can reduce an adverse affect in the position locating results caused by interference resulting from the jamming waves or the multipath.

With the present embodiment, moreover, the variation calculating section 62 calculates the standard deviation of the provisional position locating result groups, and the mobile station position locating section 66 calculates the position of the mobile station 10 using the average (x_{AV}, y_{AV}) of the provisional position locating result groups calculated by the variation calculating section 62. This allows the average (x_{AV}, y_{AV}) of the provisional position locating result groups to be calculated when the variation calculating section 62 calculates the standard deviation of the provisional position locating result groups. Therefore, no need arises for the mobile station position locating section 66 to newly calculate the average (x_{AV}, y_{AV}) of the provisional position locating result groups. This can reduce the amount of calculation required for locating the position of the mobile station 10, thereby achieving reduction in time required for calculation and electric power consumption of a computing device.

With the present embodiment, besides, the mobile station position locating system 8 includes the base-station preliminary selecting section 54 that allows the radio waves transmitted from one of the mobile station 10 and the base stations 12 to be received by the other of the mobile station 10 and the base stations 12. Then, the base-station preliminary selecting section 54 calculates the communication quality indices of wireless communications between the mobile station 10 and the plural base stations 12 based on the receiving results, thereby selecting the base stations 12 based on such communication quality indices, which regarded to favorably perform communication with the mobile station 10. The provisional position locating section 56 sets the base station sets among the base stations selected by the base-station preliminary selecting section 54 to allow the position of the mobile station 10 to be calculated using the base station sets being set. Thus, the base stations, excluding the specified base stations that are susceptible to interference resulting from the jamming waves or the multipath, are selected as the position locating base stations for use in position locating based on the communication quality indices. This enables the position of the mobile station 10 to be located using those position locating base stations, and no need arises for the provisional position locating section 56 to provisionally locate the position of the mobile station 10 in respect of the base station sets including the base stations unselected by the base-station preliminary selecting section 54. This can reduce in the amount of calculation required for locating the position of the mobile station 10, thereby achieving reductions in time required for calculation and electric power consumption of a computing device.

With the present embodiment, further, the position locating base-station setting section 64 stores the number of times the position locating base-station setting section 64 excludes the base stations from the position locating base stations in time with respect to the respective base stations 12. There may exist plural provisional position locating results groups with variations, calculated by the variation calculating section 62, which fall in the least values. Among the base stations 12 assigned to the specified base stations when calculating those plural provisional position locating results, the base stations 12 with a large number of times in exclusion from the position locating base stations are excluded on setting the position locating base stations. Thus, even if there exist the plural provisional position locating results with the least variation, the base stations 12 excluding the specified base stations that are susceptible to interference resulting from the jamming waves or the multipath, are selected as the position locating base stations for use in position locating. Thus, the position of the mobile station 10 can be located using those position locating base stations.

With the present embodiment, furthermore, the base station sets are comprised of the base stations 12 at three stations. This allows the base stations 12, excluding the specified base stations that are susceptible to interference resulting from the jamming waves or the multipath, to be selected as the position locating base stations for use in position locating. Thus, the position of the mobile station 10 can be located using those base station sets comprised of any three stations of the position locating base stations being selected.

With the present embodiment, moreover, the provisional position locating section 56 sets the base station sets which are combinations of the given number of base stations 12 less than the number of the plural base stations 12, among the plural base stations 12. Then, the position of the mobile station 10 is calculated using the determined base station sets. Among the provisional position locating results associated with the base station sets calculated by the provisional position locating section 56 for the respective base station sets, the provisional position locating result-group extracting section 60 extracts the provisional position locating results, associated with the plural base station sets from which the specified base stations are excluded, as the provisional position locating result groups.

The variation calculating section 62 calculates the variations σ of the respective provisional position locating result groups obtained, when the provisional position locating result-group extracting section 60 allows the base stations of at least part of the plural base station sets to be assigned as the specified base stations. Among the variations σ of the provisional position locating result groups calculated by the variation calculating section 62, the provisional position locating result groups with the least variations σ are calculated by the position locating base-station setting section 64 to determine the position locating base stations excluding the base stations 12 regarded to be the specified base stations. This can select the base stations 12, excluding the specified base stations that are susceptible to interference resulting from the jamming waves or the multipath, as the position locating base stations for use in the position locating.

Subsequently, description will be provided of another embodiment according to the present invention. In the following description, components parts common to those of the embodiments bear like reference numerals to omit redundant description.

### Second Embodiment

The present embodiment relates to the operations of the position locating base-station setting section 64 and the mobile station position locating section 66 and more specifically, a case in which among the respective variations σ of the provisional position locating result groups calculated by the variation calculating section 62, there exist a plurality of the least variations σ.

In the previous embodiment, on calculating the provisional position locating result group having the least variation σ, among the respective variations σ of the provisional position locating result groups calculated by the variation calculating section 62, the position locating base-station setting section 64 sets the base stations excluding the specified base station as the position locating base stations. This similarly applies to the present embodiment. Meanwhile, if there exist plural least variations σ, an operation is executed in a mode different from the operation of the previous embodiment. Like the embodiment mentioned above, a situation where the plural least variations σ are existed is not limited to a case in which there is a plurality of equalized variations σ each with the least variation, but may include a case in which in addition to a value of the variation σ having the least value, an another value falling in a given range on consideration of measurement error in operation of the provisional position locating section 56.

Among the respective variations σ of the provisional position locating result groups calculated by the variation calculating section 62, if the plural least variations σ are existed, then, the position locating base-station setting section 64 and the mobile station position locating section 66 set the position locating base stations to locate the position of the mobile station 10 in a manner described below. First, the respective plurality of provisional position locating result groups regarded to have the least variation σ, the position locating base-station setting section 64 excludes the base station regarded to be the specified base station on calculating the plurality of provisional position locating result groups, thereby determining the respective position locating base stations. Subsequently, the mobile station position locating section 66 calculates an average of the provisional position locating results calculated by the provisional position locating section 56, using the base station sets structured of plural kinds of position locating base stations determined by the position locating base-station setting section 64, as the position of the mobile station 10.

Above operations will be specified with reference to a concrete example. A case will be explained in which the magnitudes of the variations σ1 to σ5 calculated by the variation calculating section 62 are compared, and the variations σ1 and σ2 are the least variation. In this case, the provisional position locating result groups, corresponding to the plural least variations σ1 and σ2 are ones, when the first and second base stations 12A and 12B are assigned to the specified base stations, respectively. The position locating base-station setting section 64, corresponding to the provisional position locating result group when the first base station 12A is assigned to the specified base station, excludes the first base station 12A, i.e., determines the second to fifth base stations 12B to 12E, as the provisional position locating result groups. In addition, the position locating base-station setting section 64, corresponding to the provisional position locating result group when the second base station 12B is assigned to the specified base station, excludes the second base station 12B, i.e., the first base station 12A and the third to fifth base stations 12C to 12E are determined to be the position locating base stations of another kinds.

Among these, on setting the second to fifth base stations 12B to 12E to be the position locating base stations, the base station sets structured of these position locating base stations, include: the base station set (2, 3, 4); the base station set (2, 3, 5); the base station set (2, 4, 5); and the base station set (3, 4, 5). On setting the first base station 12A and the third to fifth base stations 12C to 12E to be the position locating base stations, the base station sets structured of these position locating base stations, include: the base station set (1, 3, 4); the base station set (1, 3, 5); the base station set (1, 4, 5); and the base station set (3, 4, 5). The mobile station position locating section 66 averages the provisional position locating results of the mobile station 10 calculated by the provisional position locating section 56 using the base stations sets structured of these position locating base stations of these plural kinds, thereby allocating the resulting value as the position of the mobile station 10.

That is, in the illustrated example mentioned above, an average of the position locating result S (2, 3, 4) associated with the base station set (2, 3, 4), the position locating result S (2, 3, 5) associated with the base station set (2, 3, 5), the position locating result S (2, 4, 5) associated with the base station set (2, 4, 5), the position locating result S (3, 4, 5) associated with the base station set (3, 4, 5), the position locating result S (1, 3, 4) associated with the base station set (1, 3, 4), the position locating result S (1, 3, 5) associated with the base station set (1, 3, 5) and the position locating result S (1, 4, 5) associated with the base station set (1, 4, 5) are calculated as the position of the mobile station 10. This average is calculated in the form of for instance an average for respective coordinate components of the respective position locating results. Moreover, in both of cases wherein the second to fifth base stations 12B to 12E are set to be the position locating base stations and wherein the first base station 12A and the third to fifth base stations 12C to 12E are set to be the position locating base stations, the base station set (3, 4, 5) are the base station sets structured of these position locating base stations. However, on calculating the average of the position locating results S of the mobile station position locating section 66, no need arises to overlappingly calculate the average of the position locating results S overlapping with the position locating base stations of the plural kinds, like the position locating results (3, 4, 5) associated with this base station set (3, 4, 5).

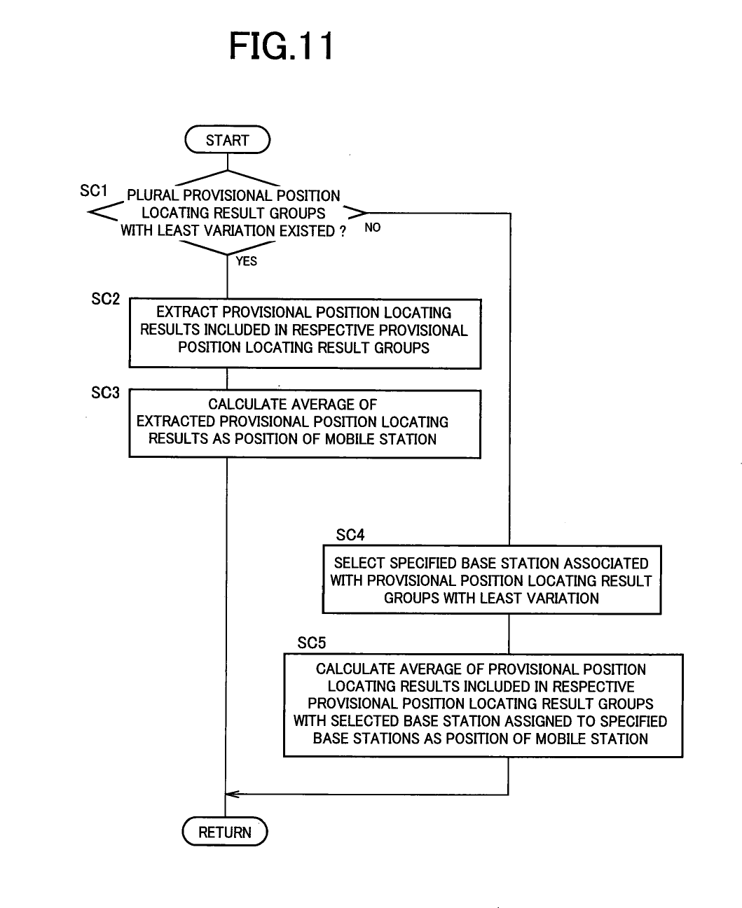

FIG. 11 is a flowchart illustrating an outline of one example of a basic sequence of control operations to be executed by the position locating base-station setting section 64 and the mobile station position locating section 66. This flowchart is executed as the position-locating station setting and mobile-station locating routine at SA13 in the flowchart shown in FIG. 9 illustrating the control operations of the mobile station position locating system 8 of the embodiment set forth above.

SC1 and SC2 correspond to the position locating base-station setting section 64. First, at SC1, the variations σ of the respective provisional position locating result groups, appearing when the respective base stations 12 calculated at SA12, are assigned to the specified base stations, are compared to each other to make a query as to whether there exist plural variations σ falling in the least value. The expression “there exist plural variations σ falling in the least value” is not limited to a case wherein there exist plural variations σ with equal least values, and may include a case wherein in addition to the variation σ having the least value, the variation σ is existed within a predetermined range preset in advance. If there exit the plural variations σ falling in the least values, the answer to current step is yes and SC2 is executed. In addition, if there exists one variation σ falling in the least value, the answer to current step is no, and SC4 is executed.

SC2 represents a step executed when there exist the plural variations σ falling in the least value at SC1. At current step, provisional position locating base stations of plural kinds are set for the respective provisional position locating result groups, which are obtained on calculating the plural variations σ with the least value. Then, the respective provisional position locating base stations of the plural kinds constitute the base station sets. In addition, results on the position-locating initiated at step SA10 using the base station sets formed in such a structure are read out, respectively.

At SC3 corresponding to the mobile station position locating section 66, an average of the results on the position-locating read out at SC2 is calculated as the position of the mobile station 10.

Meanwhile, SC4 and SC5 are executed when the answer to SC1 is no, i.e., when there exists one variation σ, and correspond to SB3 and SB4 of the routine in the previous embodiment shown in FIG. 10. At SC4, for the provisional position locating result groups in which the variation σ with the least value is calculated at SC1, the base stations assigned to the specified base station is selected as the base stations, not constituting the provisional position-locating stations.

Further, at SC5 corresponding to the mobile station position locating section 66, the average (x_{AV}, y_{AV}) of the provisional position locating results contained in the provisional position locating result groups, when the base stations 12 selected at SC4 are assigned to the specified base stations, is calculated as the position of the mobile station 10.

With the previous embodiment described above, when there are plural provisional position locating result groups having the variations σ falling in the least values calculated by the variation calculating section 62, the position locating base-station setting section 64 (i) excludes the base stations assigned to the specified base station(s) on calculating the plural provisional position locating result groups from these plural provisional position locating result groups, and (ii) sets the respective position locating base stations. The mobile station position locating section 66 calculates the average of the provisional position locating result groups calculated by the provisional position locating section 56, using the base station sets structured of the plurality of position locating base stations set by the position locating base-station setting section 64, as the position of the mobile station 10. Thus, even if there exist a plurality of provisional position locating result groups having the variation σ falling in the least values the base stations 12, excluding the specified base station that is susceptible to interference resulting from the jamming waves and the multipath, are selected as the position locating base stations for use in the position locating. Thus, the position of the mobile station 10 can be located using such position locating base stations.

### Third Embodiment

The present embodiment relates to an operation of the variation calculating section 62. In the previous embodiment, the variation calculating section 62 calculates the variations σ, representing the indices indicative of the distribution degree of the provisional position locating results contained in the provisional position locating result groups, as the standard deviation of the coordinates of the provisional position locating results included in the provisional position locating result groups expressed by the equation (2). In the present embodiment, the variation calculating section 62 defines and calculates the variations as described below.

The variation calculating section 62 checks distances of the provisional position locating results contained in the provisional position locating result groups to calculate a maximum one of the distances as a variation σ. With such calculation, the variation σ becomes an index representing the distribution degree of the provisional position locating results contained in the provisional position locating result groups.

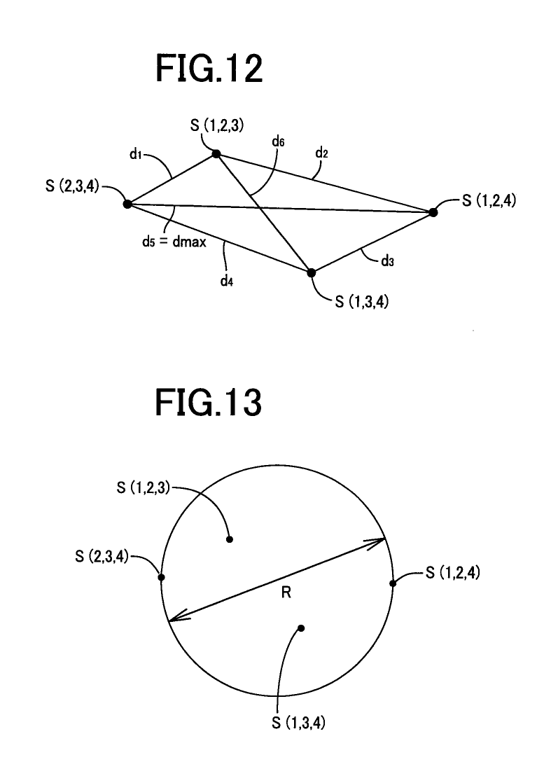

A case will be explained wherein the base stations selected by the base-station preliminary selecting section 54 (see FIG. 4) are the five base stations including the first to fifth base stations 12A to 12E with the fifth base station 12E being assigned to the specified base station. FIG. 12 illustrating how the variation calculating section 62 of the present embodiment calculates the variation σ, shows the provisional position locating results S (1, 2, 3), S (1, 2, 4), S (1, 3, 4) and S (2, 3, 4) of the provisional position locating result groups with the fifth base station 12E being assigned to the specified base station. That is, these results are obtained upon calculation with the use of the base station set (1, 2, 3), the base station set (1, 2, 4), the base station set (1, 3, 4) and the base station set (2, 3, 4). The base-station preliminary selecting section 54 calculates various relevant distances of these provisional position locating results which include, for instance: a distance d2 between S (1, 2, 3) and S (1, 2, 4); a distance d6 between S (1, 2, 3) and S (1, 3, 4); a distance d1 between S (1, 2, 3) and S (2, 3, 4); a distance d3 between S (1, 2, 4) and S (1, 3, 4); a distance d5 between S (1, 2, 4) and S (2, 3, 4); and a distance d4 between S (1, 3, 4) and S (2, 3, 4). Then, the base-station preliminary selecting section 54 selects the maximum one of these distances to allocate the value dmax to the variation of the provisional position locating result group.

With the present embodiment, the variation calculating section 62 checks a value of the longest distance from line segments each interconnecting two provisional position locating results among the provisional position locating result groups to calculate the same as the variations σ. Thus, the calculation is made such that the greater the error in the provisional position locating results, the greater will be the variations σ in the form of the longest distance among the line segments each interconnecting the two provisional position locating results among the provisional position locating result groups. This allows the position locating base-station setting section 64 to set the provisional position locating base stations on the ground of the variations σ being calculated. Thus, it becomes possible to select the base stations 12, excluding the specified base stations that are susceptible to interference resulting from the jamming waves or the multipath, as the position locating base stations for use in the position locating, so that the position of the mobile station 10 can be located using these position locating base stations. That is, this can reduce an adverse affect arising from interference caused by the jamming waves or the multipath in the position locating results.

### Fourth Embodiment

The present embodiment relates to another operation of the variation calculating section 62. In the previous embodiment, the variation calculating section 62 calculates a diameter of a circle or a sphere involving the provisional position locating result groups as the variations σ set forth above. Here, one that encompasses the provisional position locating result groups is the circle when the mobile station 10 acting as an object to be located in position moves on a flat plane, and the sphere when the mobile station 10 acting as the object to be located in position moves in a three-dimensional space. The diameter of such a circle or such a sphere is calculated as the variations σ. With such calculation, the variation σ can serve as an index representing the distribution degree of the provisional position locating results encompassed in the provisional position locating result groups.

A case will be explained wherein the base stations selected by the base-station preliminary selecting section 54 (see FIG. 4) include the five base stations including the first to fifth base stations 12A to 12E, with the fifth base station 12E being assigned to the specified base station. FIG. 13, illustrating how the variation calculating section 62 of the present embodiment calculates the variation σ, shows the provisional position locating results S (1, 2, 3), S (1, 2, 4), S (1, 3, 4) and S (2, 3, 4) of the provisional position locating result groups with the fifth base station 12E being assigned to the specified base station. That is, these results are obtained upon calculation with the use of the base station set (1, 2, 3), the base station set (1, 2, 4), the base station set (1, 3, 4) and the base station set (2, 3, 4).

As set forth above, when the mobile station 10 moves on the flat plane, the variation calculating section 62 calculates the diameter of the circle encompassing the provisional position locating result groups as the variation σ. That is, the variation calculating section 62 calculates a diameter R of a circle encompassing all of the provisional position locating results S (1, 2, 3), S (1, 2, 4), S (1, 3, 4) and S (2, 3, 4) in a manner as shown in FIG. 13. Moreover, the present embodiment has been described above with reference to the exemplary case wherein the diameter R of the circle encompassing all of the provisional position locating results S is assigned to the variation σ the mobile station 10 moves on the flat plane. However, even when the mobile station 10 moves in the three-dimensional space, a similar effect can be obtained by compelling the diameter R of the sphere, encompassing all of the provisional position locating results S, to be assigned as the variation σ.

With the present embodiment, the variation calculating section 62 calculates the diameter R of the circle or the sphere, encompassing all of the provisional position locating results, to be the variation set forth above. Thus, the calculation can be made such that the greater the errors in the provisional position locating results, the greater will be the variation σ representing the diameter of the circle or the sphere encompassing all of the provisional position locating results. The position locating base-station setting section 64 can determine the provisional position locating base stations on the ground of the variations σ being calculated. Thus, it becomes possible to select the base stations 12, excluding the specified base stations that are susceptible to interference resulting from the jamming waves or the multipath, as the position locating base stations for use in the position locating, so that the position of the mobile station 10 can be calculated using these position locating base stations. That is, this can reduce an adverse affect arising from interference caused by the jamming waves or the multipath in the position locating results.

While the embodiments according to the present invention have been described above with reference to the drawings, the present invention may be applied in other modes.

In the illustrated embodiments mentioned above, although the mobile station 10 has been described as one which moves on the flat plate, the present invention is not limited to such an example and the mobile station 10 may be of the type that moves in an airspace (in three dimension). In such a case, it may suffice for an equation, corresponding to the equation (1), to be introduced with a coordinate (x, y, z), indicative of the position of the mobile station 10, which is treated as an unknown.

In the illustrated embodiment described above, further, although the position locating information detecting section 40 detects as position locating information receiving intensity of the radio wave upon receipt at the position of the mobile station 10, the present invention is not limited to such a concept. In particular, position locating information may be, for instance, a transmit time of the radio wave for locating the position at the mobile station 10 or receive times thereof at the respective base stations 12.

In this case, the distances between the mobile station 10 and the respective base stations 12 can be calculated by multiplying a propagation time of the position locating radio wave acquired on such a transmit time and a receive time by a speed of the radio wave. Thus, the position of the mobile station 10 can be located. In addition, the position of the mobile station 10 can be located based on a time difference between the radio waves received by the plural base stations. In these cases, the position locating radio wave transmitted by the mobile station 10 may preferably include a PN (Pseudo Noise) code. This is because sharp peak on correlation on the PN code can perform synchronized detection using a match dot filter on a receive site for thereby detecting a receive time with increased precision.

In the embodiments set forth above, further, the communication state detecting section 42 detects, as the index representing the communicating state of radio wave, receiving intensity (RSSI) of the position locating radio wave, but the present invention is not limited to such receiving intensity. In a case where the position locating radio wave includes an error detection code, for instance, the receiving intensity may be substituted by a BER (Bit Error Rate) of a received radio wave calculated based on such an error detection code. In another alternative case where the position locating radio wave includes diffusion code, a peak value of a correlation value between the diffusion code and a replica code identical thereto can be employed. That is, the position locating radio wave includes another index as long as it varies at a certain rate depending on the communication state during transmission and reception of the radio wave. In the embodiments set forth above, furthermore, while both of the position locating information detecting section 40 and the communication state detecting section 42 detect the position locating radio wave transmitted from the mobile station 10, the present invention is not limited to such a mode. In an alternative, the mobile station 10 may be arranged to transmit a radio wave for detecting position locating information by the position locating information detecting section 40, and another radio wave for detecting an index of a communication state of the radio wave by the communication state detecting section 42. The respective base stations 12 may be arranged to detect position locating information by the position locating information detecting section 40, and the index indicative of the communication state of the radio wave by the communication state detecting section 42 depending on a radio wave received.

In the embodiments set forth above, moreover, while the base-station preliminary selecting section 54, the provisional position locating section 56, the storage section 58, the provisional position locating result-group extracting section 60, the variation calculating section 62, the position locating base-station setting section 64 and the mobile station position locating section 66 are functions owned by the servers 14, the present invention is not limited to such a structure. For instance, these sections may be incorporated as functions in either one of the base stations 12, so that no need arises for the servers 14 to be provided.

In the embodiments set forth above, besides, values of the receive intensities of the radio waves detected by the position locating information detecting section 40 and the communication state detecting section 42, may be instantaneous values of receive intensities of the radio waves received at the wireless section 34, or may include an average value of the instantaneous values detected by a predetermined number of times.

In the embodiments set forth above, further, the position locating radio wave is transmitted from the mobile station 10 and received at the base stations 12, the present invention is not limited to such an arrangement. That is, the mobile station 10 may include the position locating information detecting section 40 and the communication state detecting section 42, and the position locating radio waves transmitted from the wireless section 34 of the respective base stations 12 is received at the wireless section 24 of the mobile station 10. The detections of position locating information of the received radio waves and the indices indicative of the communication states of those radio waves are executed at the position locating information detecting section 40 and the communication state detecting section 42.

In the embodiments set forth above, furthermore, although the base-station preliminary selecting section 54 selects only one of the base stations 12 in which the index indicative of the communication state, detected by the communication state detecting section 42 of the respective base station 12, exceeds the predetermined threshold value, the present invention is not limited to such a mode. For instance, an alternative may be arranged to select a given number of base stations in order from a large index indicative of the communication state detected by the communication state detecting section 42 of the respective base station 12 such that a predetermined number of base stations are selected.

In the embodiments set forth above, moreover, although the mobile station position locating section 66 calculates the average of the provisional position locating results obtained by the provisional position locating section 56, as the position of the mobile station 10, using the base station sets comprised of the provisional position locating base stations which are set by the position locating base-station setting section 64, the present invention is not limited to such a mode. For instance, an intermediate value of the provisional position locating results obtained by the provisional position locating section 56, may be calculated as the position of the mobile station 10, using the base station sets structured of the provisional position locating base stations set by the position locating base-station setting section 64, thus a similar effect being rendered.

In the embodiments set forth above, besides, while the mobile station position locating system 8 or the position locating base station selecting system 9 has the structures including the base-station preliminary selecting sections 54, and the provisional position locating section 56 provisionally locates the position of the mobile station 10 using the base stations selected by the base-station preliminary selecting section 54, the present invention is not limited to such a mode. That is, the mobile station position locating system 8 or the position locating base station selecting system 9 may have structures not including the base-station preliminary selecting section 54. In this case, the provisional position locating section 56 may be arranged to provisionally locate the position of the mobile station 10 based on the receive results of all of the base stations 12 that receive the radio wave transmitted from the mobile station 10, thus a certain degree of effect being rendered.

What is claimed is:

1. A mobile station position locating method in which one of a mobile station or a plurality of position locating base stations transmits a radio wave, and the other of the mobile station and the plurality of position locating base stations receives the radio wave to locate the position of the mobile station based on a result of received wave, the mobile station position locating method comprising steps of:
a provisional position locating step that, setting among plural base stations a plurality of base station sets which are combinations of a predetermined number of base stations less than the number of plural base stations, locates the position of the mobile station using the plurality of base station sets;
a provisional position locating result group extracting step that extracts, among provisional position locating results associated with the base station sets which are set in the provisional position locating step for the respective base station sets, the provisional position locating results associated with the plurality of base station sets each not including a specified base station, as provisional position locating result groups;
a variation calculating step that calculates respective variations of the provisional position locating result groups obtained in the provisional position locating result group extracting step, by assigning each of at least one of the plural base stations to the specified base station;
a position locating base station setting step that sets the base stations excluding the base station assigned to the specified base station as the position locating base stations on calculating the provisional position locating result group with the least variation, among the variations of the provisional position locating result groups calculated in the variations calculating step; and
a mobile station position locating step that locates the position of the mobile station, based on the position locating results obtained by using the base station sets constituted of the position locating base stations which are set in the position locating base station setting step.

2. The mobile station position locating method according to claim 1, wherein:
the mobile station position locating step locates an average of the provisional position locating results obtained in the provisional position locating step as the mobile station, using the base station sets constituted of the position locating base stations set in the position locating base station setting step.

3. The mobile station position locating method according to claim 1, wherein:
the variation calculating step calculates standard deviations of the provisional position locating result groups as the variations thereof.

4. The mobile station position locating method according to claim 3, wherein:
the variation calculating step calculates an average of the provisional position locating results; and
the mobile station position locating step locates the position of the mobile station using the average of the provisional position locating results calculated in the variation calculating step.

5. The mobile station position locating method according to claim 1, wherein:
the variation calculating step calculates a value of a length of the longest line segments each connecting between two of the provisional position locating results of the provisional position locating result group as the variation.

6. The mobile station position locating method according to claim 1, wherein:
the variation calculating step calculates a diameter of a circle or a sphere encompassing the provisional position locating result group as the variation.

7. The mobile station position locating method according to claim 1, further comprising:
a base station preliminary selecting step that (i) calculates, based on a received result of the radio wave transmitted from one of the mobile station and the plurality of base stations and received at the other of the mobile station and the plurality of base stations, communication quality indexes of the radio wave in a wireless communication between the mobile station and the plural respective base stations, and (ii) selects the base stations determined to perform favorable communication with the mobile station based on the communication quality indexes; and
the provisional position locating step sets the base station set based on the base stations selected by the base-station preliminary selecting step, and locates the position of the mobile station using the base station set.

8. The mobile station position locating method according to claim 1, wherein;
the position locating base station setting step (i) stores the number of times the base stations are excluded from the position locating base stations in the position locating base station setting step, and (ii) sets the position locating base stations excluding the base station with a large number of excluding times among the base stations assigned to the specified base stations on calculating plural provisional position locating result groups, when there exist the plural provisional position locating result groups with the variations calculated in the variation calculating step are regarded to have the least values.

9. The mobile station position locating method according to claim 2, wherein:
the position locating base station setting step sets, the position locating base stations excluding the base stations assigned to the specified base station on calculating the plural provisional position locating results when there exist the plural provisional position locating result groups with the least variation, calculated in the variation calculating step; and
the mobile station position locating step locates the average of the provisional position locating results obtained in the provisional position locating step, using the base station sets constituted of the position locating base stations which are respectively set in the position locating base station setting step.

10. The mobile station position locating method according to claim 1, wherein:
the base station set comprise three base stations.

11. A position locating base station selecting method which selects, on locating a position of a mobile station based on a received result of a radio wave transmitted from one of the mobile station or the plurality of position locating base stations received at other of the mobile station and a plurality of position locating base stations, the plurality of position locating base stations among plural base stations whose number of base stations exceeds a number required as the plurality of position locating base stations, the position locating base station selecting method comprising step of:
a provisional position locating step that, setting among plural base stations a base station set which is combination of a predetermined number of base stations less than the number of plural base stations, locates the position of the mobile station using the base station set;
a provisional position locating result group extracting step that extracts, among provisional position locating results associated with the base station sets which are set in the provisional position locating step for the respective base station sets, the provisional position locating results associated with the plurality of base station sets each not including a specified base station, as provisional position locating result groups;
a variation calculating step that calculates respective variations of the provisional position locating result groups obtained in the provisional position locating result group extracting step, by assigning each of at least one of the plural base stations to the specified base station; and
a position locating base station setting step that sets the base stations excluding the base station assigned to the specified base station as the position locating base stations on calculating the provisional position locating result group with the least variation, among the variations of the provisional position locating result groups calculated in the variations calculating step.

12. A mobile station position locating system in which one of a mobile station or a plurality of position locating base stations transmits a radio wave, and the other of the mobile station and the plurality of position locating base stations receives the radio wave to locate the position of the mobile station based on a result of received wave, the mobile station position locating system comprising:
a provisional position locating section that, setting among plural base stations a base station set which is combination of a predetermined number of base stations less than the number of plural base stations, locates the position of the mobile station using the base station set;
a provisional position locating result group extracting section that extracts, among provisional position locating results associated with the base station sets which are set in the provisional position locating section for the respective base station sets, the provisional position locating results associated with the plurality of base station sets each not including a specified base station, as provisional position locating result groups;
a variation calculating section that calculates respective variations of the provisional position locating result groups obtained in the provisional position locating result group extracting section, by assigning each of at least one of the plural base stations to the specified base station;
a position locating base station setting section that sets the base stations excluding the base station assigned to the specified base station as the position locating base stations on calculating the provisional position locating result group with the least variation, among the variations of the provisional position locating result groups calculated in the variations calculating section; and
a mobile station position locating section that locates the position of the mobile station, based on the position locating results obtained by using the base station sets constituted of the position locating base stations which are set in the position locating base station setting section.
